(19) United States
(12) Patent Application Publication
(10) Pub. No.: US 2017/0274664 A1
(43) Pub. Date: Sep. 28, 2017

(54) INK JET HEAD AND INK JET DEVICE

(71) Applicant: Panasonic Intellectual Property Management Co., Ltd., Osaka (JP)

(72) Inventors: YUTAKA UETA, Hyogo (JP); YOUSUKE TOYOFUKU, Fukuoka (JP); TAKAMI ISHIDA, Osaka (JP); HIDEAKI HORIO, Fukuoka (JP)

(21) Appl. No.: 15/427,085

(22) Filed: Feb. 8, 2017

(30) Foreign Application Priority Data
Mar. 25, 2016 (JP) 2016-061827

(51) Int. Cl. B41J 2/175

(52) U.S. Cl. CPC B41J 2/17563

(57) ABSTRACT

An ink jet head includes an actuator and a structure body. The actuator includes a thin film portion, a pressure chamber layer, and a filter. The thin film portion is deformed by application of a voltage to apply a pressure to an ink. The pressure chamber layer is formed on a surface of the pressure chamber and has a recessed portion. The filter is integrally formed with the pressure chamber layer so as to be disposed in the recessed portion, the filter having an aperture smaller than a diameter of a nozzle. The actuator is stacked on an upper surface of the structure body and joined to the upper surface thereof. A pressure chamber is formed by the recessed portion and the upper surface of the structure body, and the filter is disposed in the pressure chamber.

### BACKGROUND

1. Technical Field

The present disclosure relates to an ink jet head that ejects an ink on a surface to be printed and an ink jet device including the ink jet head.

2. Description of the Related Art

An ink jet device ejects an ink from an ink jet head to perform printing or drawing on a surface to be printed. The ink jet head incorporated in the ink jet device includes a pressure chamber that is filled with an ink, a flow path for introducing the ink to the pressure chamber, a nozzle connected to the pressure chamber, and an actuator that applies a pressure to the ink filled in the pressure chamber.

For example, a recessed portion is formed in a lower surface of the actuator and the actuator is stacked on an upper surface of a structure body having the nozzle. The recessed portion formed in the lower surface of the actuator is closed by the upper surface of the structure body, so that the pressure chamber is formed. In such a state, the pressure chamber is connected to the nozzle by a communication flow path formed in the structure body. When the actuator is driven to increase a pressure of the pressure chamber, the ink filled in the pressure chamber is ejected from the nozzle formed in the structure body.

Japanese Patent No. 4,732,416 discloses a configuration of removing a contaminant contained in an ink when the ink flows in a pressure chamber. In this configuration, a group of protrusions are disposed in a structure body having a nozzle, and the contaminant is captured by the group of protrusions.

### SUMMARY

A first aspect of the present disclosure relates to an ink jet head that has a pressure chamber and ejects an ink filled in the pressure chamber from a nozzle. The ink jet head according to the first aspect includes an actuator and a structure body. The actuator applies a pressure to the ink filled in the pressure chamber. The structure body supplies the ink to the pressure chamber and introduces the ink in the pressure chamber to the nozzle. The actuator includes a thin film portion, a pressure chamber layer, and a filter. The thin film portion is deformed by application of a voltage to apply a pressure to the ink. The pressure chamber layer is formed on a surface of the thin film portion and has a recessed portion. The filter is integrally formed with the pressure chamber layer so as to be disposed in the recessed portion, the filter having an aperture smaller than at least a diameter of the nozzle. The actuator is joined to the structure body so as to be stacked on an upper surface of the structure body. The pressure chamber is formed by the recessed portion and the upper surface of the structure body, and the filter is disposed in the pressure chamber so as to intersect with a flow of the ink flowing in the pressure chamber toward the nozzle.

According to the ink jet head of the first aspect, the filter is integrally formed with the pressure chamber layer formed on the surface of thin film portion, and thus when the actuator is joined to the structure body, it is not necessary to perform a precise operation such as bonding the filter to the surface of the thin film portion. The filter is integrally formed with the pressure chamber layer, and thus the filter has high mechanical strength and breakage hardly occurs in the filter. Further, the filter is disposed in the recessed portion of the pressure chamber layer, and thus the filter is disposed in the pressure chamber simply by joining the actuator to the structure body. As a result, according to the ink jet head of the first aspect, it is possible to reliably install the filter in the pressure chamber without any breakage by a smooth operation.

A second aspect of the present disclosure relates to an ink jet device. The ink jet device according to the second aspect includes the ink jet head according to the first aspect and an ink supply unit that supplies the ink to the ink jet head.

According to the ink jet device of the second aspect, the ink jet head according to the first aspect is used, and thus it is possible to reliably install a filter in a pressure chamber without any breakage. As a result, it is possible to surely prevent a contaminant larger than a diameter of a nozzle from reaching the nozzle, and thus performance of the ink jet device can be improved.

As described above, according to the present disclosure, it is possible to provide an ink jet head and an ink jet device in which a filter can be reliably installed in a pressure chamber without any breakage by a smooth operation.

Effects and significance of the present disclosure will become more apparent from the description of an exemplary embodiment below. However, the exemplary embodiment described below is merely an example when the present disclosure is implemented, and the present disclosure is not limited to the following description of the exemplary embodiment.

### BRIEF DESCRIPTION OF THE DRAWINGS

FIG. 1A is a view illustrating a configuration of an ink jet head according to a first exemplary embodiment;

FIG. 1B is a view schematically illustrating a configuration in which an actuator is combined with a structure body, according to the first exemplary embodiment;

FIG. 2A is an enlarged view illustrating a part of the actuator and the structure body according to the first exemplary embodiment;

FIG. 2B is a view schematically illustrating a part of a main flow path and a pressure chamber according to the first exemplary embodiment;

FIG. 2C is a view schematically illustrating an arrangement of nozzles on the structure body according to the first exemplary embodiment;

FIG. 3 is a partial perspective view illustrating a configuration near the pressure chamber according to the first exemplary embodiment;

FIG. 4A is a plan view illustrating the configuration near the pressure chamber according to the first exemplary embodiment, as perspectively viewed from above;

FIG. 4B is a cross-sectional view obtained by cutting the configuration of FIG. 4A at a position of line 4B-4B;

FIG. 4C is a cross-sectional view obtained by cutting the configuration of FIG. 4A at a position of line 4C-4C;

FIGS. 5A to 5D are views each schematically illustrating a process of forming a pressure chamber layer according to the first exemplary embodiment;

FIGS. 6A to 6C are views each schematically illustrating a process of forming a pressure chamber layer according to the first exemplary embodiment;

FIG. 6D is an enlarged view illustrating a configuration around a filter according to the first exemplary embodiment;

FIG. 7 is a block diagram illustrating a configuration of an ink jet device according to the first exemplary embodiment;

FIG. 8A is a plan view illustrating a configuration near a pressure chamber according to a second exemplary embodiment, as perspectively viewed from above;

FIG. 8B is a cross-sectional view obtained by cutting the configuration of FIG. 8A at a position of line 8B-8B;

FIG. 8C is an enlarged view illustrating a vicinity of a gap of the configuration shown in FIG. 8A; and

FIGS. 9A to 9C are plan views each illustrating a configuration near a pressure chamber according to a variation, as perspectively viewed from above.

### DETAILED DESCRIPTION OF EMBODIMENT

Prior to the explanation to exemplary embodiments of the present disclosure, problems of a conventional configuration are explained. In the configuration of Japanese Patent No. 4,732,416, a group of protrusions are disposed in a structure body, and thus when an actuator is stacked on the structure body, distal ends of the group of protrusions needs to be bonded to a lower surface of the actuator. At this time, if a drive unit of the actuator is constituted by using a thin film portion formed of a diaphragm layer, a piezoelectric body layer, and the like, when the actuator is stacked on the structure body, it is necessary to perform a precise operation of bonding and fixing the distal ends of the group of protrusions to the fine thin film portion.

If some of the group of protrusions accidentally collides with or abuts against other members at an assemble step and the like, breakage of an elongated protrusion such as folding of an elongated protrusion may occur. In this case, a large gap is formed in the broken protrusion, and thus a contaminant passes through this gap to reach a nozzle. The nozzle is thus clogged with the contaminant and ejection precision of ink may be degraded.

In view of the above problems, the present disclosure provides an ink jet head and an ink jet device in which a filter can be reliably installed in a pressure chamber without any breakage by a smooth operation even when a drive unit of an actuator is constituted by using a thin film portion.

The exemplary embodiments of the present disclosure are described below with reference to the drawings. For convenience, X, Y, and Z axes that are perpendicular to each other are indicated in the respective drawings. A direction of the Z axis corresponds to a height direction of ink jet head 1 and a positive direction of the Z axis corresponds to a downward direction. A direction of the X axis corresponds to a thickness direction of ink jet head 1 and a direction of the Y axis corresponds to a width direction of ink jet head 1. Ink jet head 1 ejects an ink in the positive direction of the Z axis (the downward direction).

### First Exemplary Embodiment

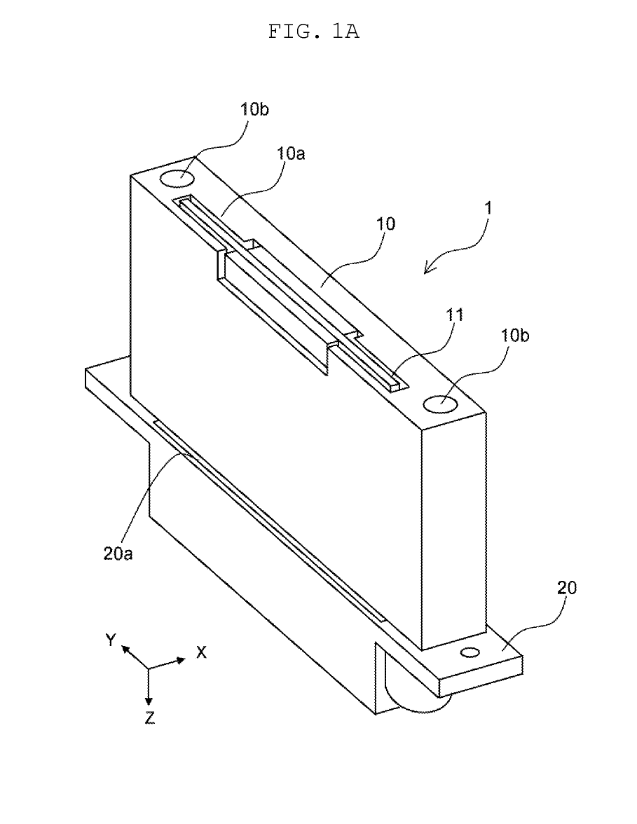

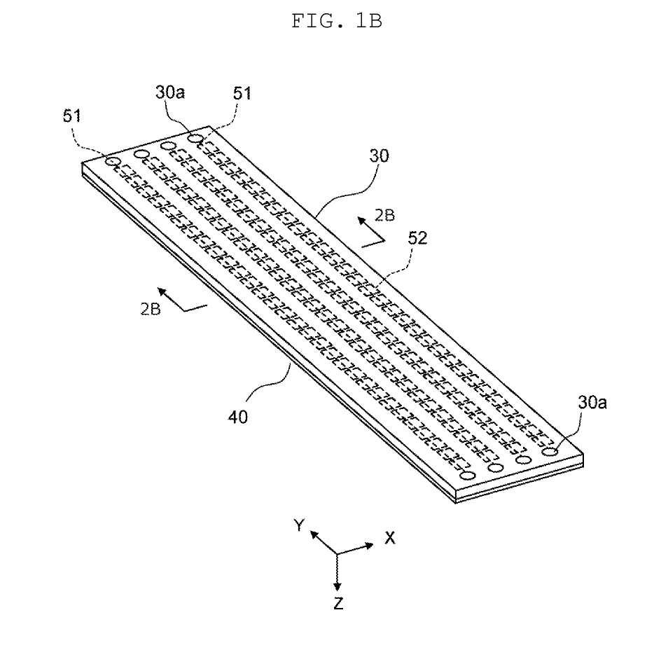

FIG. 1A is a view illustrating a configuration of ink jet head 1 according to a first exemplary embodiment. FIG. 1B is a view schematically illustrating a configuration in which actuator 30 is combined with structure body 40, according to the first exemplary embodiment.

As shown in FIG. 1A, ink jet head 1 includes accommodation box 10 and head base 20. Accommodation box 10 is removable from head base 20.

Accommodation box 10 is formed of a rectangular parallelepiped box with its lower surface open. Cutout 10a connected to the inside of accommodation box 10 is formed in an upper surface thereof, and circuit board 11 is accommodated in accommodation box 10 through cutout 10a. A drive circuit for driving actuator 30 is mounted on circuit board 11. Holes 10b, which each have a circular shape, are respectively formed on Y-axis positive side of cutout 10a and on Y-axis negative side of cutout 10a. Holes 10b are used for introducing ink supply tubes (not shown) to the inside of accommodation box 10.

Head base 20 is formed of a frame body that has vertically-open rectangular parallelepiped opening 20a at its center portion. Actuator 30 and structure body 40 shown in FIG. 1B are installed on a lower end of opening 20a. Actuator 30 is electrically connected to circuit board 11 in opening 20a by flexible printed circuits (FPCs).

As shown in FIG. 1B, actuator 30 is formed of a rectangular plate. Actuator 30 is stacked on an upper surface of structure body 40. Structure body 40 is also formed of a rectangular plate. Four main flow paths 51 disposed side by side in the direction of the X axis are formed in structure body 40.

Four ink supply ports 30a disposed side by side in the direction of the X axis are formed at each of ends of actuator 30 on the positive and negative sides of the Y axis. Two ink supply ports 30a disposed in parallel to each other in the direction of the Y axis are connected to one independent main flow path 51.

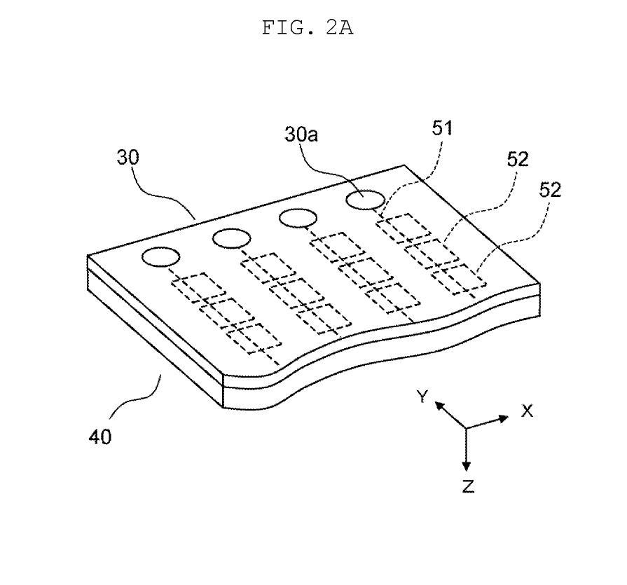

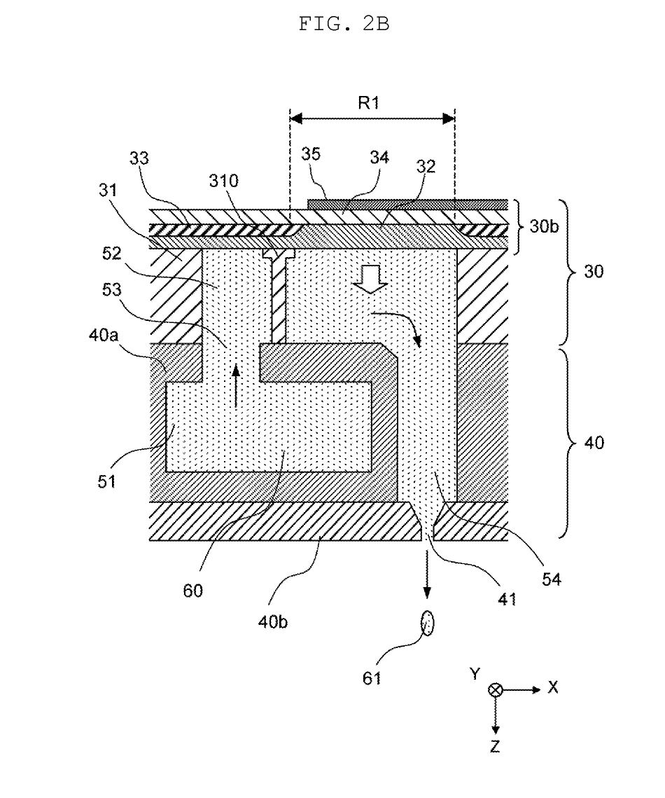

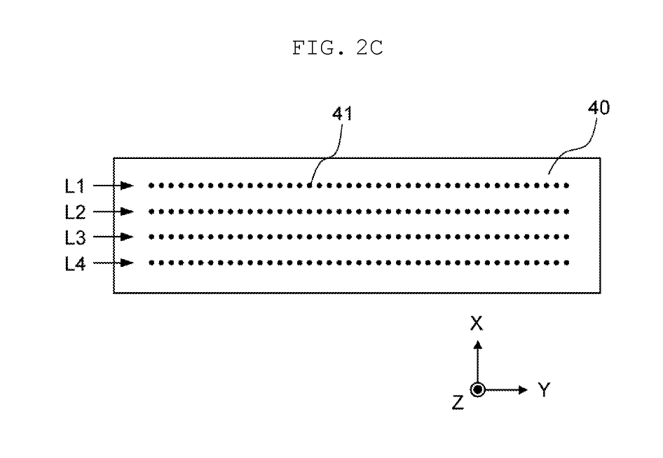

FIG. 2A is an enlarged view illustrating an end part of the configuration shown in FIG. 1B on the positive side of the Y axis.

A recessed portion that is described later is formed in a rear surface of actuator 30. As actuator 30 is stacked on structure body 40, pressure chamber 52 is formed between the recessed portion formed in the rear surface of actuator 30 and the upper surface of structure body 40. Pressure chamber 52 is connected via communication flow path 53 formed in structure body 40 (see FIG. 2B) to main flow path 51.

A terminal group (not shown) for connecting the FPCs of circuit board 11 is formed at each of ends of an upper surface of actuator 30 on the positive and negative sides of the X axis. The terminal groups are used for applying a voltage (a drive signal) to piezoelectric body layer 34 (see FIG. 2B) of actuator 30.

As described above, an end of main flow path 51 is connected to ink supply port 30a. A large number of pressure chambers 52 are disposed along main flow path 51, and each pressure chamber 52 is connected to main flow path 51 via each communication flow path 53.

Returning to FIG. 1B, a pipe (not shown) is fitted into each of eight ink supply ports 30a and an ink is supplied from an ink supply tube (not shown) to each of the pipes. The pipe is supported by a support member placed in opening 20a shown in FIG. 1A and the tube that supplies an ink to the pipe is drawn outside through hole 10b. The ink is supplied to ink supply port 30a through the ink supply tube and the pipe. The ink thus flows in main flow path 51 and communication flow path 53 and is supplied to pressure chamber 52.

An ink of the same color is supplied to two ink supply ports 30a disposed in parallel to each other in the direction of the Y axis. On the other hand, inks of different colors are supplied to four ink supply ports 30a disposed side by side in the direction of the X axis. Accordingly, in the configuration of FIG. 1B, four color inks are supplied to actuator 30. Thus, pressure chambers 52 disposed side by side in the direction of the Y axis are filled with an ink of the same color. On the other hand, pressure chambers 52 disposed side by side in the direction of the X axis are filled with inks of different colors. A unit of actuator 30 and structure body 40 is installed on the lower end of opening 20a of head base 20 shown in FIG. 1A. The four color inks are thus ejected from a lower surface of head base 20.

An ink of the same color may be supplied to four main flow paths 51. Alternatively, an ink of the same color may be supplied to two main flow paths 51 on the positive side of the X axis, and an ink of the same color, which is different from the color of the ink supplied to two main flow paths 51 on the positive side of the X axis, may be supplied to two main flow paths 51 on the negative side of the X axis.

FIG. 2B is a cross-sectional view schematically illustrating a cross-section obtained by cutting a vicinity of pressure chamber 52 on the positive side of the X axis (the right side) shown in FIG. 2A at a center position of pressure chamber 52 in the direction of the Y axis (a position of line 2B-2B in FIG. 1B) along a plane parallel to plane X-Z.

Ink 60 having flown into main flow path 51 passes through communication flow path 53 to be filled in pressure chamber 52. Structure body 40 includes upper member 40a that includes main flow path 51 and communication flow paths 53, 54 and lower member 40b that includes nozzle 41. A substantially circular hole functioning as nozzle 41 is formed in a part of lower member 40b corresponding to communication flow path 54 extending from pressure chamber 52 in the positive direction of the Z axis. A diameter of nozzle 41 is gradually reduced toward the positive direction of the Z axis and is constant near an exit.

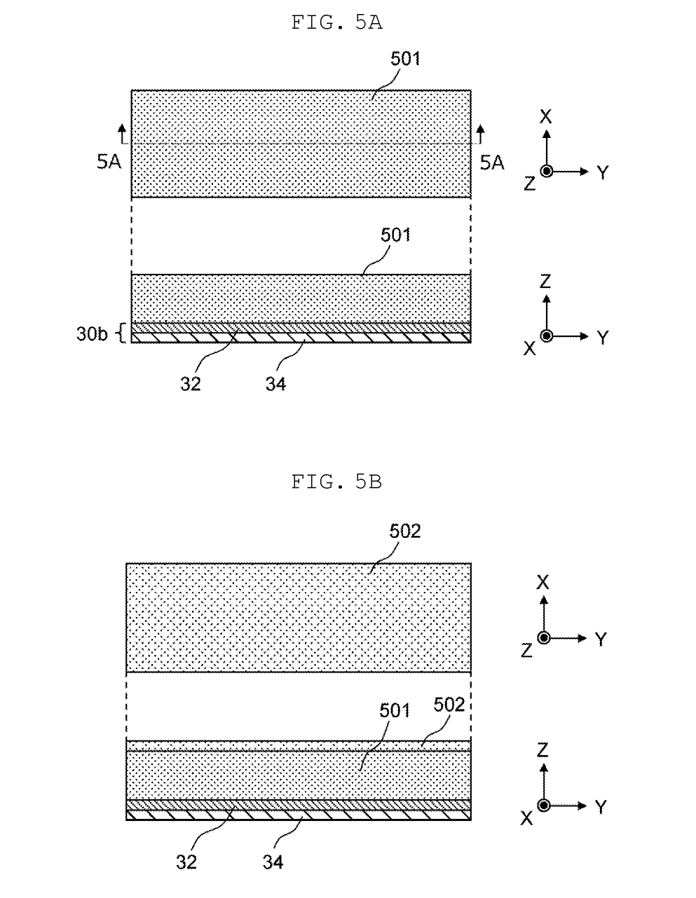

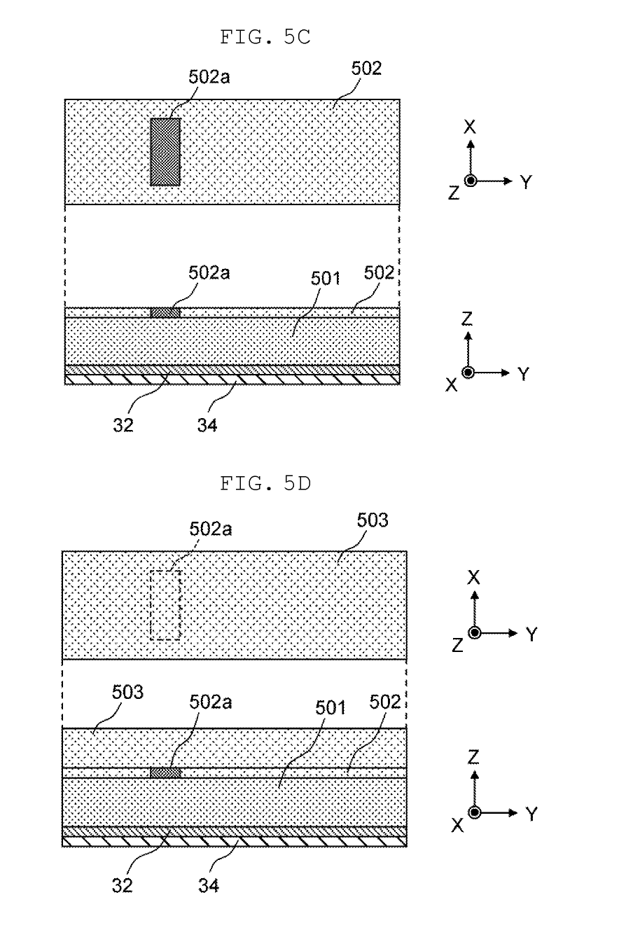

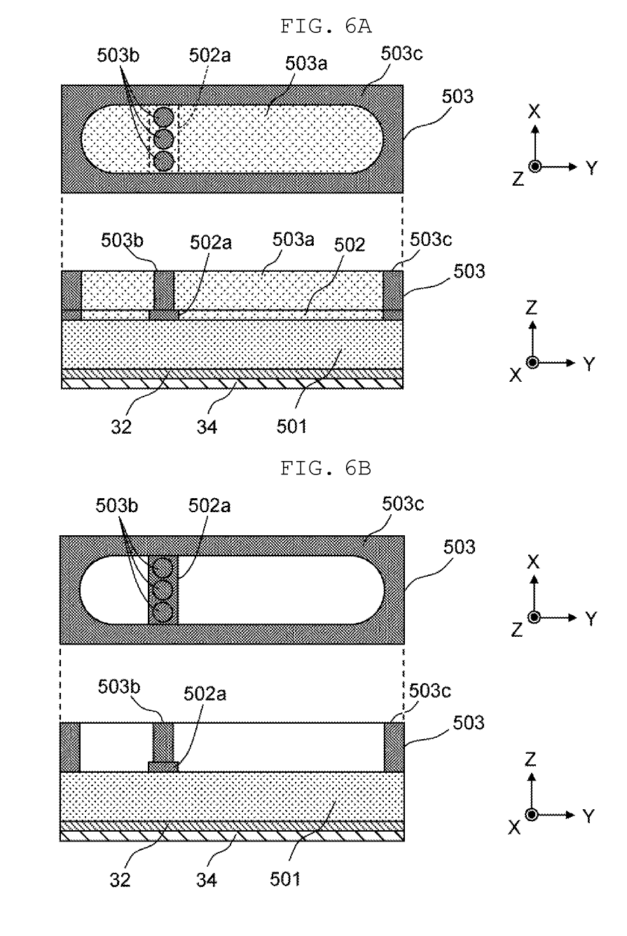

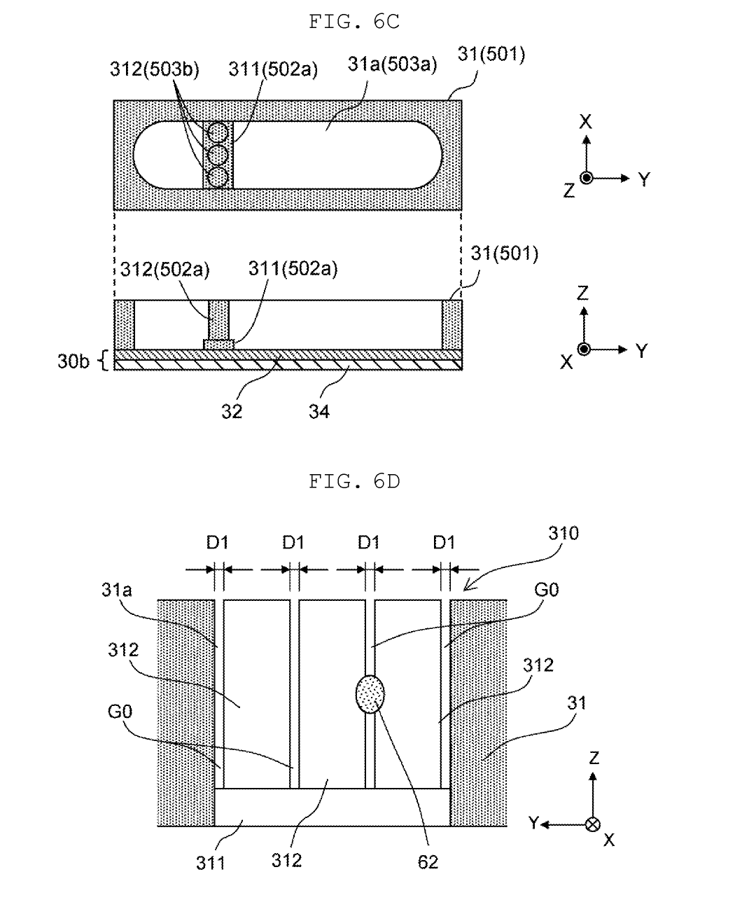

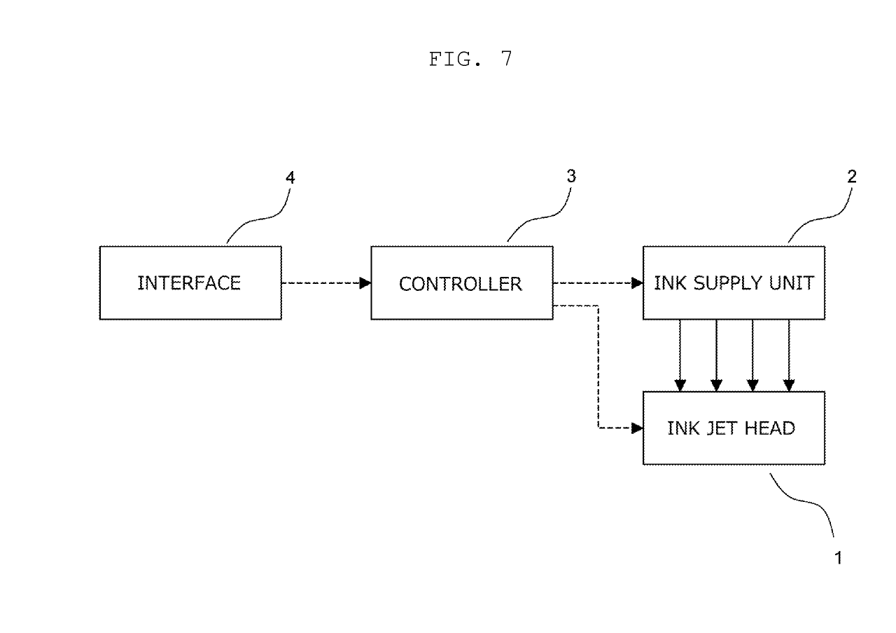

Actuator 30 is configured by stacking thin film portion 30b including diaphragm layer 32, insulating layer 33, piezoelectric body layer 34, and electrode layer 35 on pressure chamber layer 31. Diaphragm layer 32, insulating layer 33, piezoelectric body layer 34, and electrode layer 35 are formed by using a vacuum deposition technique such as sputtering. Alternatively, these layers can be formed by using other film forming techniques such as coating. Pressure chamber layer 31 is formed by etching a Si substrate. A process of forming pressure chamber layer 31 is described later with reference to FIGS. 5A to 6D.

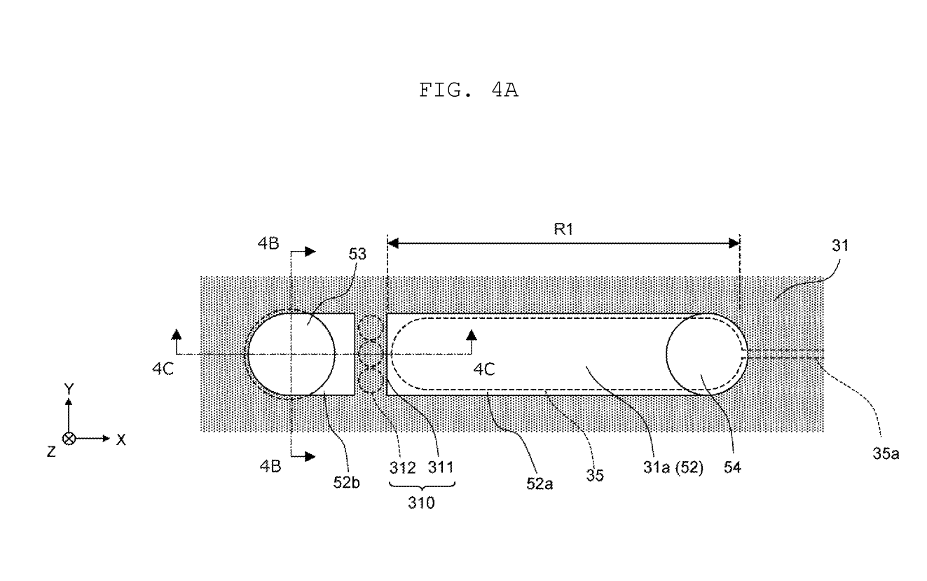

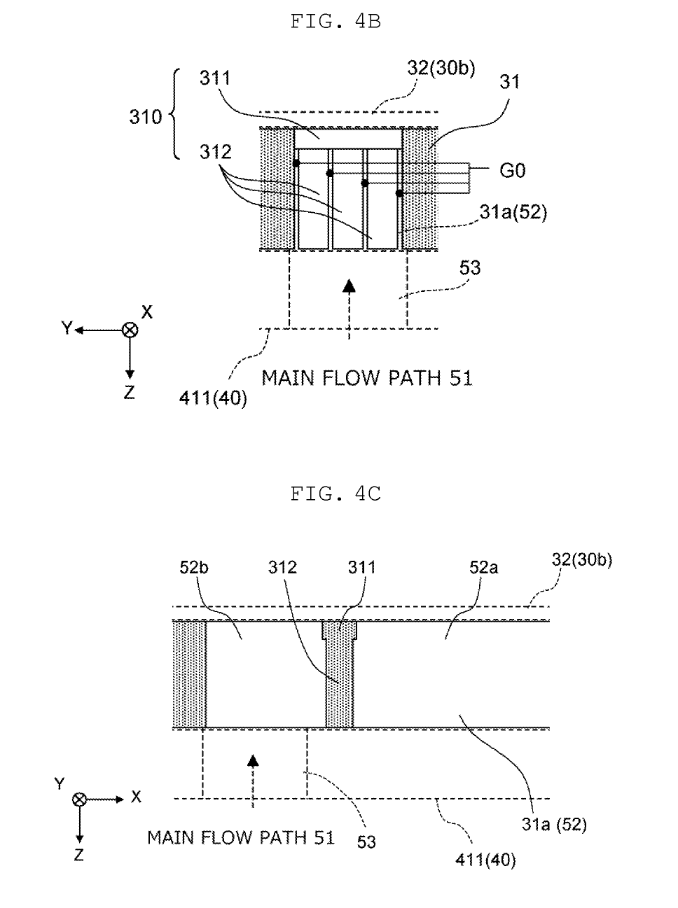

Pressure chamber 52 is formed by attaching upper member 40a to a lower surface of pressure chamber layer 31. Filter 310 is integrally formed with pressure chamber layer 31. Filter 310 is disposed in pressure chamber 52 so as to intersect with a flow of ink 60 flowing in pressure chamber 52 toward a nozzle. A configuration of filter 310 is described later with reference to FIGS. 4A to 6D.

Diaphragm layer 32 is made of a conductive metallic material and also functions as a lower electrode (a common electrode) of piezoelectric body layer 34. Insulating layer 33 insulates piezoelectric body layer 34 from diaphragm layer 32. That is, insulating layer 33 blocks application of a voltage to piezoelectric body layer 34 other than piezoelectric functional region R1. Piezoelectric body layer 34 is made of, for example, lead zirconate titanate (PZT). Piezoelectric body layer 34 has a film thickness of a few micrometers (μm). Electrode layer 35 is made of a conductive material. Electrode layer 35 is made of, for example, titanium containing a noble metal. Electrode layer 35 has a film thickness of approximately 0.2 μm.

When a voltage is applied to electrode layer 35, piezoelectric body layer 34 in piezoelectric functional region R1 is deformed in the direction of the Z axis and thus diaphragm layer 32 is also deformed. When diaphragm layer 32 in piezoelectric functional region R1 is deformed downward, a capacity of pressure chamber 52 decreases and a pressure of ink 60 filled in pressure chamber 52 increases. Droplet 61 of ink 60 is thus ejected from nozzle 41.

Pressure chamber layer 31, diaphragm layer 32, insulating layer 33, piezoelectric body layer 34, and electrode layer 35 are not necessarily formed as a single layer, and these layers can be formed of a plurality of layers. Other layers can be further disposed between these layers.

FIG. 2C schematically shows an arrangement of nozzles 41 on structure body 40.

As shown in FIG. 2C, a plurality of nozzles 41 are disposed in a line on structure body 40. Four lines L1 to L4 of nozzles 41 are disposed on structure body 40. For example, 200 nozzles 41 are provided in each of lines L1 to L4 at constant intervals. A number of nozzles 41 in each line is not limited to 200.

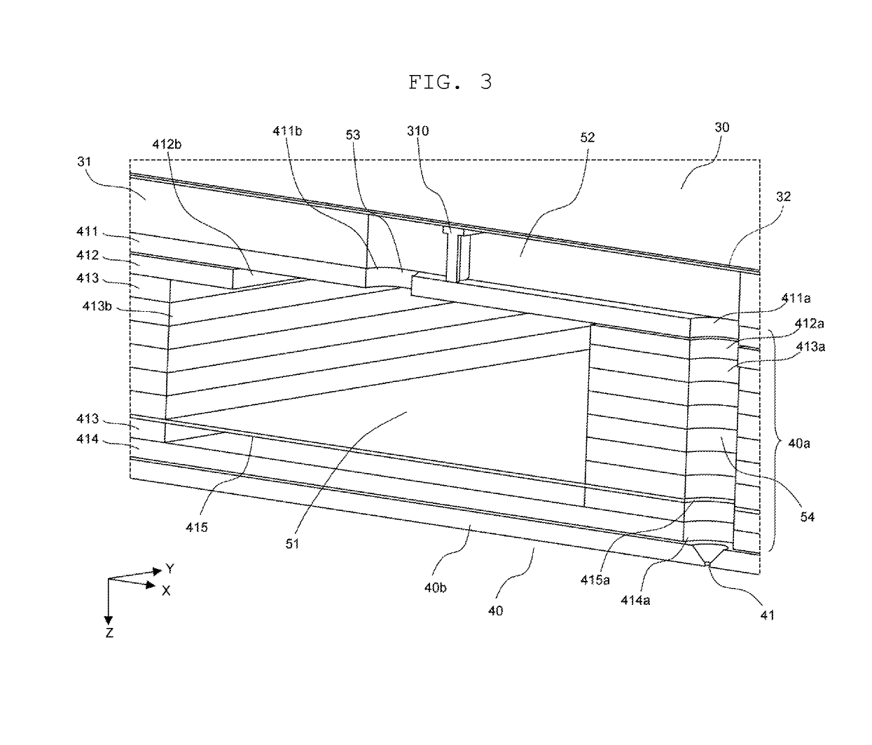

FIG. 3 is a partial perspective view illustrating a cross-section of a configuration near pressure chamber 52.

As shown in FIG. 3, upper member 40a of structure body 40 is constituted by stacking plate-like body 411, plate-like body 412, seven plate-like bodies 413, and plate-like body 414. Each of plate-like bodies 411 to 414 has a predetermined thickness and has the same outline as that of structure body 40 in plan view. Seven plate-like bodies 413 have the same configuration. Thin dumper 415 is interposed between first plate-like body 413 and second plate-like body 413 from the bottom. Damper 415 is used for absorbing pressure waves applied from communication flow path 53 to main flow path 51 when actuator 30 is driven to deform diaphragm layer 32 downward (in the positive direction of the Z axis).

Holes 411a, 412a for forming communication flow path 54 are formed in plate-like bodies 411, 412, respectively. Holes 411a, 412a are substantially circular. Holes 413a for forming communication flow path 54 are formed also in seven plate-like bodies 413. Holes 413a are also substantially circular. Holes 414a, 415a for forming communication flow path 54 are formed also in plate-like body 414 and damper 415. Diameters of holes 411a to 415a are substantially equal to each other. Centers of holes 411a to 415a are also identical to each other.

Opening 412b is formed in a part of plate-like body 412 at an area corresponding to main flow path 51, and opening 413b is formed in a part of plate-like body 413 at an area corresponding to main flow path 51. A width of opening 412b in the direction of the X axis is narrower than that of opening 413b. In plan view, an edge of opening 412b on the positive side of the X axis is identical to that of the opening 413b. Main flow path 51 is divided by damper 415.

Opening 411b is formed in a part of plate-like body 411 at an area corresponding to communication flow path 53. Opening 411b is substantially circular. Opening 411b may have an oval shape that is long in the direction of the X axis, or may have other shapes.

In pressure chamber 52, filter 310 is disposed on the positive side of the X axis with respect to communication flow path 53. Filter 310 is integrally formed with pressure chamber layer 31. An ink having flown from main flow path 51 through communication flow path 53 into pressure chamber 52 passes through filter 310 and then enters a right-side (the positive side of the X axis) region of pressure chamber 52. When the ink passes through the filter 310, a contaminant that has a larger diameter than that of nozzle 41, which is contained in the ink, is removed.

In this way, the ink having a contaminant with a large diameter removed therefrom is filled in the right-side region of pressure chamber 52. When actuator 30 is driven to increase a pressure of pressure chamber 52, the ink filled in the right-side region of pressure chamber 52 flows in communication flow path 54 formed of holes 411a, 412a and holes 413a, 414a, 415a to be ejected from nozzle 41.

As shown in FIG. 3, according to the first exemplary embodiment, upper member 40a of structure body 40 is constituted by stacking plate-like bodies 411, 412, 413, 414. Lower member 40b is bonded to a lower surface of upper member 40a or is joined to the lower surface of upper member 40a by thermal diffusion. Upper member 40a is bonded to a lower surface of pressure chamber layer 31, and thus structure body 40 including upper member 40a and lower member 40b is attached to actuator 30. That is, by bonding structure body 40 having communication flow path 54 to actuator 30, pressure chamber 52 is connected to communication flow path 54. Simultaneously, pressure chamber 52 is also connected to communication flow path 53. An end surface of filter 310 on the positive side of the Z axis contacts to an upper surface of plate-like body 411. This end surface is bonded to the upper surface of plate-like body 411.

FIG. 4A is a plan view illustrating a configuration near pressure chamber 52, as perspectively viewed from above. FIG. 4A shows a state where thin film portion 30b disposed on an upper side of pressure chamber 52 (the negative side of the Z axis) is omitted. For convenience, electrode layer 35 and wire 35a connected to electrode layer 35 are shown by broken lines in FIG. 4A. FIGS. 4B, 4C are cross-sectional views obtained by cutting a configuration of FIG. 4A at a position of line 4B-4B and a position of line 4C-4C, respectively. For convenience, diaphragm layer 32 (thin film portion 30b) and communication flow path 53 are shown by broken lines in FIGS. 4B and 4C.

As shown in FIGS. 4A to 4C, recessed portion 31a functioning as pressure chamber 52 is formed in pressure chamber layer 31. Recessed portion 31a is recessed in the negative direction of the Z axis and a bottom surface of recessed portion 31a is diaphragm layer 32 that is a part of thin film portion 30b. In plan view, recessed portion 31a has an outline that is long in the direction of the X axis. Specifically, the outline of recessed portion 31a has a shape that connects ends of two arcs by lines. Communication flow path 53 is positioned at an end of recessed portion 31a on the negative side of the X axis, and communication flow path 54 is positioned at an end of recessed portion 31a on the positive side of the X axis.

Filter 310 is formed so as to partition recessed portion 31a in the direction of the X axis. Filter 310 is integrally connected to two inner side surfaces of recessed portion 31a which are opposed to each other in the direction of the Y axis. That is, filter 310 includes connecting part 311 and three pillar parts 312. Connecting part 311 is formed on a surface of diaphragm layer 32 (thin film portion 30b) within recessed portion 31a so as to connect these two inner side surfaces. Three pillar parts 312 extend from connecting part 311 to an upper surface of plate-like body 411 (structure body 40).

Three pillar parts 312 have a columnar shape, and have a same height and a same diameter. An X axis direction width of connecting part 311 is larger than a diameter of pillar part 312. Three pillar parts 312 are integrally formed with connecting part 311 so as to be disposed in a line in the direction of the Y axis. An end surface of pillar part 312 on the positive side of the Z axis is bonded to the upper surface of plate-like body 411 (structure body 40).

There is gap G0 between adjacent pillar parts 312. There is also gap G0 between pillar part 312 disposed on an end side in an arrangement direction and an inner surface of recessed portion 31a. A Y axis direction width of gap G0 is smaller than a diameter of nozzle 41 shown in FIG. 3. For example, a diameter of an exit of nozzle 41 is 20 micrometers (μm) and a width of gap G0 is 15 μm. The width of gap G0 is constant over an entire length of pillar part 312. Gap G0 constitutes an aperture of filter 310.

By filter 310 disposed as described above, pressure chamber 52 is partitioned into region 52a on the positive side of the X axis and region 52b on the negative side of the X axis. An ink having flown from communication flow path 53 into region 52b flows through filter 310 into region 52a. At this time, a contaminant that is contained in the ink and has a diameter larger than the diameter of nozzle 41 cannot pass through gap G0 and thus remains on the X-axis negative side of pillar part 312. As a result, the ink having a contaminant with a large diameter removed therefrom is filled in region 52a.

The contaminant remaining on the X-axis negative side of pillar part 312 is peeled from pillar part 312 when actuator 30 is driven. That is, a part of an ink within region 52a of pressure chamber 52 flows backward to region 52b through filter 310 by a pressure applied by actuator 30 when the ink is ejected from nozzle 41. With this flow of the ink, the contaminant remaining on the X-axis negative side of pillar part 312 is peeled from pillar part 312. As a result, it is possible to prevent filter 310 from being clogged with the contaminant, and a flow of the ink from region 52b to region 52a is secured.

FIGS. 5A to 5D and 6A to 6C schematically show a process of forming pressure chamber layer 31 according to the first exemplary embodiment. An upper part of each drawing shows a schematic diagram of a configuration near pressure chamber 52 at each step, as viewed from the positive side of the Z axis. A lower part of each drawing shows a schematic diagram of a cross-section (a cross-section along line 5A-5A) obtained by cutting the drawing in the upper part at a central position in the direction of the X axis.

As shown in FIG. 5A, substrate layer 501 made of silicon is formed on a surface of diaphragm layer 32 (thin film portion 30b). Substrate layer 501 finally becomes pressure chamber layer 31. For this reason, a thickness of substrate layer 501 is adjusted to be equal to that of pressure chamber layer 31.

Next, as shown in FIG. 5B, resist layer 502 (a thin film) is applied on a surface of substrate layer 501. Further, as shown in FIG. 5C, light exposure is performed on resist layer 502 in rectangular region 502a. Region 502a corresponds to connecting part 311 of filter 310.

Next, as shown in FIG. 5D, resist layer 503 (a thick film) is further applied on a surface of resist layer 502. Further, as shown in FIG. 6A, light exposure is performed on resist layer 503 in a region other than region 503a, that is, resist layer 503 in three circular regions 503b and region 503c around region 503a. Simultaneously, light exposure is also performed on resist layer 502. Region 503a corresponds to recessed portion 31a, and region 503b corresponds to pillar part 312 of filter 310.

Next, as shown in FIG. 6B, resist layers 502, 503 are developed, so that a pattern constituted by an exposed part is formed. This pattern is then transferred to substrate layer 501 by dry etching. As a result, as shown in FIG. 6C, pressure chamber layer 31 that includes recessed portion 31a, connecting part 311, and three pillar parts 312 is formed on the surface of diaphragm layer 32 (thin film portion 30b).

When pressure chamber layer 31 is formed by the process described above, connecting part 311 is directly formed on the surface of diaphragm layer 32 (thin film portion 30b). Connecting part 311 is integrally formed with pressure chamber layer 31 so as to connect inner side surfaces of recessed portion 31a which are opposed to each other in the direction of the X axis. Further, three pillar parts 312 are integrally formed with a surface of connecting part 311. In this way, pillar part 312 is integrally formed with pressure chamber layer 31 together with connecting part 311, and thus pillar part 312 has high mechanical strength.

FIG. 6D is an enlarged view of a configuration around filter 310.

Connecting part 311 is formed at a deepest part of recessed portion 31a. Pillar part 312 is formed so as to extend from connecting part 311 in the positive direction of the Z axis. An end surface of pillar part 312 on the positive side of the Z axis is on a same plane as a surface of pressure chamber layer 31 on the positive side of the Z axis. Width D1 of gap G0 is smaller than a diameter of nozzle 41. Accordingly, contaminant 62 that is larger than width D1 cannot pass through gap G0. An ink flows through gap G0 into region 52a shown in FIG. 4A.

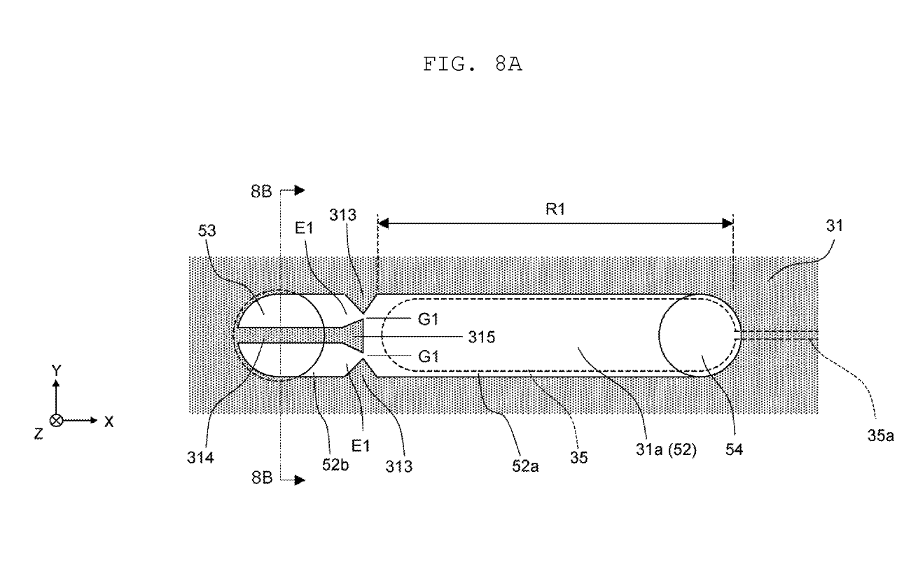

FIG. 7 is a block diagram of a configuration of an ink jet device according to the first exemplary embodiment.

The ink jet device includes, in addition to ink jet head 1 with the configuration described above, ink supply unit 2, controller 3, and interface 4.

Ink supply unit 2 includes the above-described tube for supplying an ink to ink jet head 1, an ink tank connected to the tube, and a pump for supplying an ink from the ink tank to the tube. Controller 3 includes a CPU and a memory and controls ink jet head 1 and ink supply unit 2 according to a program stored in the memory. Interface 4 accepts an input of drawing information such as a character and a graphic to be printed and outputs the drawing information to controller 3.

Controller 3 controls ink jet head 1 according to the input drawing information to perform printing or drawing on a surface to be printed. In this way, an ink is ejected from nozzles 41 corresponding to a print image onto a surface to be printed, and printing or drawing is performed on the surface to be printed.

### Effects of First Exemplary Embodiment

According to the first exemplary embodiment, the following effects are obtained.

Filter 310 is integrally formed with pressure chamber layer 31 formed on a surface of thin film portion 30b (diaphragm layer 32) shown in FIG. 4B, and thus when actuator 30 is joined to structure body 40, it is not necessary to perform a precise operation of bonding filter 310 to the surface of thin film portion 30b (diaphragm layer 32). Pillar part 312 of filter 310 is integrally formed with pressure chamber layer 31 together with connecting part 311, and thus pillar part 312 has high mechanical strength and breakage hardly occurs in pillar part 312. Further, filter 310 is disposed in recessed portion 31a of pressure chamber layer 31, and thus filter 310 is disposed in pressure chamber 52 simply by joining actuator 30 to structure body 40. As a result, it is possible to reliably install filter 310 in pressure chamber 52 without any breakage by a smooth operation.

Filter 310 includes three pillar parts 312, and thus four gaps G0 can be formed as shown in FIG. 6D. Accordingly, a flow of an ink is hardly hindered by filter 310, and the ink can be smoothly introduced to region 52a shown in FIG. 4A.

A number of pillar parts 312 is not limited to three and may be other numbers. For example, it is permissible that two pillar parts 312 are disposed and three gaps G0 are formed. Alternatively, it is permissible that four pillar parts 312 are disposed and five gaps G0 are formed. A position of gap G0 is not necessarily limited to the position described in the first exemplary embodiment, and it is permissible that pillar part 312 disposed on an end side in the direction of the Y axis is connected to an inner side surface of recessed portion 31a and gap G0 is omitted. The respective gaps G0 do not necessarily have a same width, and as long as the width is smaller than a diameter of nozzle 41, widths of gaps G0 may be different from each other.

As shown in FIGS. 4B and 4C, in the configuration of the first exemplary embodiment, thin film portion 30b disposed at a position of recessed portion 31a is supported by connecting part 311, and thus even when thinning of thin film portion 30b is facilitated to execute more precise ink ejection control, excessive deformation and a lack of strength in thin film portion 30b can be compensated for connecting part 311.

### Second Exemplary Embodiment

According to a second exemplary embodiment, filter 310 is formed of a protruding part that protrudes from an inner side surface of recessed portion 31a. Configurations other than filter 310 are identical to those of the first exemplary embodiment.

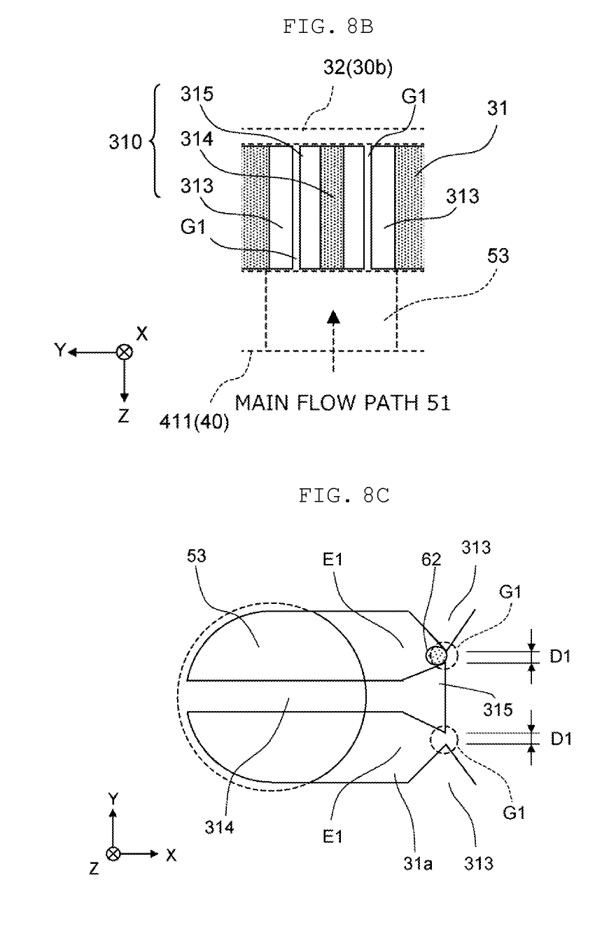

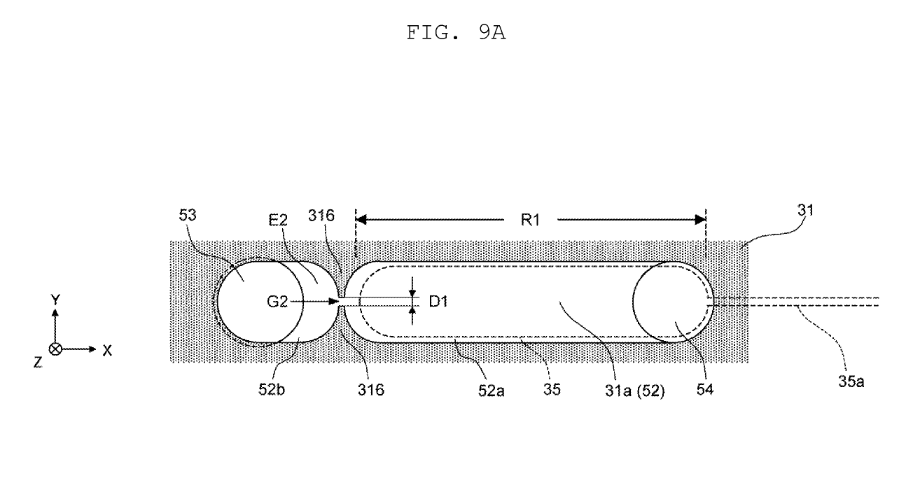

FIG. 8A is a plan view illustrating a configuration near pressure chamber 52 according to the second exemplary embodiment, as perspectively viewed from above. FIG. 8B is a cross-sectional view obtained by cutting a configuration of FIG. 8A at a position of line 8B-8B. FIG. 8C is an enlarged view illustrating a vicinity of a gap of the configuration shown in FIG. 8A.

FIG. 8A is a plan view illustrating the configuration near pressure chamber 52 as perspectively viewed from above. FIG. 8A shows a state where thin film portion 30b disposed on an upper side of pressure chamber 52 (a negative side of a Z axis) is omitted. For convenience, electrode layer 35 and wire 35a connected to electrode layer 35 are shown by broken lines in FIG. 8A. FIG. 8B is a cross-sectional view obtained by cutting the configuration of FIG. 8A at the position of line 8B-8B. For convenience, diaphragm layer 32 (thin film portion 30b) and communication flow path 53 are shown by broken lines in FIG. 8B.

As shown in FIGS. 8A and 8B, according to the second exemplary embodiment, filter 310 includes two first protruding parts 313 and one second protruding part 314. First protruding parts 313 respectively protrude from positions of two inner side surfaces of recessed portion 31a which are opposed to each other in a direction of a Y axis. Second protruding part 314 protrudes from a position of an inner side surface of recessed portion 31a on a negative side of an X axis in a direction perpendicular to a protruding direction of first protruding part 313.

First protruding part 313 has a substantially isosceles triangular shape in cross-section when cut along a plane parallel to an X-Y plane. First protruding part 313 extends from a surface of pressure chamber layer 31 on a positive side of the Z axis to a surface of pressure chamber layer 31 on the negative side of the Z axis. Ridge lines of two first protruding parts 313 are at the same position in a direction of the X axis.

Second protruding part 314 protrudes from the inner side surface of recessed portion 31a at an intermediate position of recessed portion 31a in the direction of the Y axis. Second protruding part 314 extends from the surface of pressure chamber layer 31 on the positive side of the Z axis to the surface of pressure chamber layer 31 on the negative side of the Z axis. A width of second protruding part 314 in the direction of the Y axis is constant from the root position to a connecting position of end part 315. End part 315 has a substantially isosceles triangular shape in cross-section when cut along a plane parallel to an X-Y plane. Ridge lines of two corners of end part 315 are at the same position in the direction of the X axis, and are close to the ridge lines of two first protruding parts 313.

Gap G1 that is smaller than a diameter of nozzle 41 is formed between first protruding part 313 on a positive side of the Y axis and end part 315 of second protruding part 314. Gap G1 that is smaller than the diameter of nozzle 41 is also formed between first protruding part 313 on a negative side of the Y axis and end part 315 of second protruding part 314. Further, introducing part E1, which introduces an ink to gap G1 by gradually narrowing a flow path of the ink, is formed by one of inclined surfaces on the negative side of the X axis of each of two first protruding parts 313 and one of two inclines surfaces of end part 315 of second protruding part 314.

Pressure chamber layer 31 and filter 310 according to the second exemplary embodiment are formed through, for example, the same process as that described in the first exemplary embodiment with reference to FIGS. 5A to 6C. Accordingly, first protruding parts 313 and second protruding part 314 are integrally formed with pressure chamber layer 31 when pressure chamber layer 31 is formed on a surface of diaphragm layer 32 (thin film portion 30b).

FIG. 8C is an enlarged view illustrating the vicinity of gap G1 of the configuration shown in FIG. 8A.

Gap G1 is formed between first protruding part 313 and end part 315 of second protruding part 314. Similarly to the first exemplary embodiment, width D1 of gap G1 is smaller than the diameter of nozzle 41. Accordingly, contaminant 62 that is larger than width D1 cannot pass through gap G1. An ink flows through gap G1 into region 52a shown in FIG. 4A. Gap G1 constitutes an aperture of filter 310.

### Effects of Second Exemplary Embodiment

As shown in FIGS. 8A, 8B, similarly to the first exemplary embodiment, filter 310 is integrally formed with pressure chamber layer 31 formed on a surface of thin film portion 30b (diaphragm layer 32) also in the second exemplary embodiment and thus when actuator 30 is joined to structure body 40, it is not necessary to perform a precise operation of bonding filter 310 to the surface of thin film portion 30b (diaphragm layer 32). First protruding part 313 and second protruding part 314 that constitute filter 310 are integrally formed with pressure chamber layer 31, and thus first protruding part 313 and second protruding part 314 have high mechanical strength and breakage hardly occurs in first protruding part 313 and second protruding part 314. Further, filter 310 is disposed in recessed portion 31a of pressure chamber layer 31, and thus filter 310 is disposed in pressure chamber 52 simply by joining actuator 30 to structure body 40. As a result, it is possible to reliably install filter 310 in pressure chamber 52 without any breakage by a smooth operation.

According to the second exemplary embodiment, first protruding part 313 that constitutes filter 310 protrudes so as to rise from an inner side surface of recessed portion 31a, and thus breakage such as fracturing of first protruding part 313 hardly occurs as compared to pillar part 312 according to the first exemplary embodiment. Second protruding part 314 that constitutes filter 310 is also formed so as to protrude like a wall from a full range of the inner side surface of recessed portion 31a in a direction of a Z axis, and thus breakage such as fracturing of second protruding part 314 hardly occurs as compared to pillar part 312 according to the first exemplary embodiment. As described above, according to the second exemplary embodiment, mechanical strength of filter 310 is higher than that of first exemplary embodiment. As a result, it is possible to reliably install filter 310 in pressure chamber layer 31 without any breakage.

According to the second exemplary embodiment, as shown in FIG. 8A, a flow path of an ink is introduced to gap G1 by gradually narrowed by introducing part E1. Therefore, an ink having flown from communication flow path 53 into region 52b of pressure chamber 52 can be smoothly introduced to gap G1.

While connecting part 311 according to the first exemplary embodiment is removed from the configuration of filter 310 in the second exemplary embodiment, it is permissible to further include a configuration corresponding to connecting part 311 in filter 310 according to the second exemplary embodiment. In this case, a connecting part is formed so as to connect two inner side surfaces of recessed portion 31a in a direction of a Y axis at ends of two first protruding parts 313 shown in FIG. 8C on a negative side of the Z axis. At this time, the connecting part is formed so as to bridge not only ends of two first protruding parts 313 on the negative side of the Z axis but also end part 315 of second protruding part 314. As a result, mechanical strength of not only two first protruding parts 313 but also second protruding part 314 can be increased.

### Variations

In addition to the first and second exemplary embodiments described above, the exemplary embodiments of the present disclosure can be variously varied.

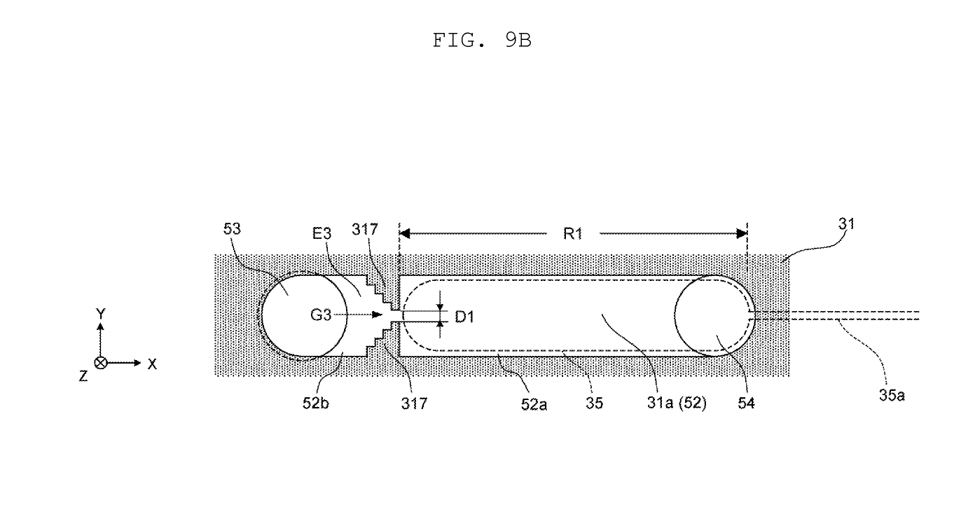

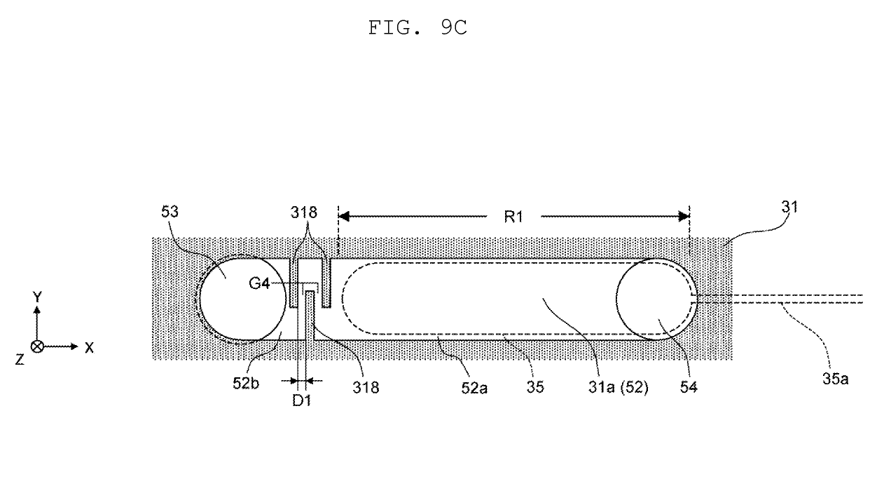

FIGS. 9A to 9C are plan views each illustrating a configuration near pressure chamber 52 according to a variation, as perspectively viewed from above.

According to a variation of FIG. 9A, filter 310 includes two protruding parts 316. Protruding parts 316 (third protruding part, fourth protruding part) protrude respectively from two inner side surfaces of recessed portion 31a which are opposed to each other, so that gap G2 is formed. Side surfaces of protruding part 316 on a negative side of an X axis and on a positive side of an X axis each has an arc shape. Introducing part E2, which introduces an ink to gap G2 by gradually narrowing a flow path of the ink, is formed by side surfaces on the negative side of the X axis of protruding parts 316. Similarly to the first and second exemplary embodiments, a width of gap G2 in a direction of a Y axis is width D1 that is smaller than a diameter of nozzle 41. Gap G2 constitutes an aperture of filter 310.

According to a variation of FIG. 9B, filter 310 includes two protruding parts 317. Protruding parts 317 (third protruding part, fourth protruding part) protrude respectively from two inner side surfaces of recessed portion 31a which are opposed to each other, so that gap G3 is formed. A side surface of protruding part 317 on the negative side of the X axis has a stepped shape. Introducing part E3, which introduces an ink to gap G3 by gradually narrowing a flow path of the ink, is formed by side surfaces on the negative side of the X axis of protruding parts 317. Similarly to the first and second exemplary embodiments, a width of gap G3 in the direction of the Y axis is width D1 that is smaller than the diameter of nozzle 41. Gap G3 constitutes an aperture of filter 310.

According to a variation of FIG. 9C, filter 310 includes three protruding parts 318. Protruding parts 318 (third protruding part, fourth protruding part) protrude respectively from two inner side surfaces of recessed portion 31a which are opposed to each other, so that gap G4 is formed. In this variation, a width direction of gap G4 is a direction of the X axis. Similarly to the first and second exemplary embodiments, a width of gap G4 is width D1 that is smaller than the diameter of nozzle 41. Gap G4 constitutes an aperture of filter 310.

According to any of the variations of FIGS. 9A to 9C, it is possible to prevent a contaminant that is larger than the diameter of nozzle 41 from entering region 52a from region 52b. Similarly to the first and second exemplary embodiments, it is possible to reliably install filter 310 in pressure chamber 52 without any breakage by a smooth operation. However, according to the variations of FIGS. 9A to 9C, there is only one gap for passing an ink, and thus it is difficult for the ink to flow from region 52b to region 52a as compared to the first and second exemplary embodiments. Therefore, in order to enable the ink to smoothly flow from region 52b to region 52a, it is preferable to employ the configurations of the first and second exemplary embodiments.

Also in the variations of FIGS. 9A to 9C, it is permissible to further include a configuration corresponding to connecting part 311 according to the first exemplary embodiment in the configuration of filter 310.

As long as filter 310 is integrally formed with pressure chamber layer 31, various variations other than the configurations of FIGS. 9A to 9C are possible. For example, a plurality of pillar parts that connect inner side surfaces of recessed portion 31a may be formed side by side in a direction of a Z axis at intervals of width D1.

While upper member 40a of structure body 40 is constituted by stacking a plurality of plate-like bodies 411, 412, 413, 414 in the first exemplary embodiment, a method for constituting structure body 40 is not limited thereto. For example, upper six plate-like bodies 413 of seven plate-like bodies 413 shown in FIG. 3 may be integrally formed by a single member. Alternatively, these six plate-like bodies 413 and plate-like bodies 411, 412 may be integrally formed by a single member.

A shape of pressure chamber 52 and a shape and configuration of main flow path 51 and communication flow paths 53, 54 are not necessarily limited to those described in the first exemplary embodiment. While an ink is supplied from two ink supply ports 30a disposed in parallel to each other in a direction of the Y axis to one main flow path in the first exemplary embodiment, one ink supply port 30a may be provided for one main flow path.

The exemplary embodiments of the present disclosure can be variously and appropriately varied within the technical scope described in the claims.

What is claimed is:

1. An ink jet head that has a pressure chamber and ejects an ink filled in the pressure chamber from a nozzle, the ink jet head comprising:
an actuator that applies a pressure to the ink filled in the pressure chamber; and
a structure body that supplies the ink to the pressure chamber and introduces the ink in the pressure chamber to the nozzle,
wherein the actuator includes
a thin film portion that is deformed by application of a voltage to apply a pressure to the ink,
a pressure chamber layer that is formed on a surface of the thin film portion and has a recessed portion, and
a filter that is integrally formed with the pressure chamber layer so as to be disposed in the recessed portion, the filter having an aperture smaller than at least a diameter of the nozzle,
the actuator is joined to the structure body so as to be stacked on an upper surface of the structure body,
the pressure chamber is formed by the recessed portion and the upper surface of the structure body, and
the filter is disposed in the pressure chamber so as to intersect with a flow of the ink flowing in the pressure chamber toward the nozzle.

2. The ink jet head according to claim 1, wherein the filter includes a connecting part that is formed on the surface of the thin film portion in the recessed portion so as to connect two inner side surfaces of the recessed portion which are opposed to each other.

3. The ink jet head according to claim 2, wherein:
the filter includes a plurality of pillar parts that extend from the connecting part to the upper surface of the structure body, and
the aperture is constituted by a gap between two adjacent pillar parts among the plurality of pillar parts or a gap between one of the two inner side surfaces of the recessed portion and one of the plurality of pillar parts.

4. The ink jet head according to claim 1, wherein the filter is integrally connected to at least one of two inner side surfaces of the recessed portion which are opposed to each other.

5. The ink jet head according to claim 4, wherein the filter includes a protruding part that protrudes from each of the two inner side surfaces.

6. The ink jet head according to claim 4, wherein:
the filter includes a first protruding part and a second protruding part, the first protruding part protruding from each of the two inner side surfaces, the second protruding part protruding from another inner side surface that is different from the two inner side surfaces in a direction intersecting with a protruding direction of the first protruding part, and
the aperture is constituted by a gap between the first protruding part and the second protruding part.

7. The ink jet head according to claim 6, wherein
the first protruding part and the second protruding part are configured so as to form an introducing part that introduces the ink to the gap by gradually narrowing a flow path of the ink flowing in the pressure chamber.

8. The ink jet head according to claim 4, wherein:
the filter includes a third protruding part and a fourth protruding part, the third protruding part protruding from one of the two inner side surfaces, the fourth protruding part protruding from another of the two inner side surfaces,
the aperture is constituted by a gap between the third protruding part and the fourth protruding part.

9. The ink jet head according to claim 8, wherein the third protruding part and the fourth protruding part are configured so as to form an introducing part that introduces the ink to the gap by gradually narrowing a flow path of the ink flowing in the pressure chamber.

10. An ink jet device comprising:
the ink jet head according to claim 1; and
an ink supply unit that supplies the ink to the ink jet head.
